(19) United States
(12) Patent Application Publication
(10) Pub. No.: US 2009/0087521 A1
(43) Pub. Date: Apr. 2, 2009

(54) PARTICULATE FILLED EDIBLE PRODUCT AND PROCESS FOR MAKING

(76) Inventors: Michael E. Belanger, Richland, MI (US); Maria Denelle Ruhlman, Battle Creek, MI (US); James G. Kincaid, Battle Creek, MI (US); Chris Willoughby, Battle Creek, MI (US)

Correspondence Address: Randall L. Shoemaker, Reg. No. 43,118;Dickinson Wright PLLC, Ste. 2000, 38525 Woodward Ave, Bloomfield Hills, MI, 48304-2970, US

(21) Appl. No.: 12/240,276

(22) Filed: Sep. 29, 2008

Related U.S. Application Data
(60) Provisional application No. 60/975,828, filed on Sep. 28, 2007.

(51) Int. Cl. A21D 13/08; A23L 1/275; A23G 3/54

(52) U.S. Cl. 426/94; 426/250; 426/283

(57) ABSTRACT

The subject invention relates to a particulate filled edible product and a method of making the particulate filled edible product. The edible product comprises an edible shell of dough that defines an enclosed cavity having a cavity volume. At least one edible food particulate is disposed within the cavity. The food particulate has a particulate volume that is less than the cavity volume and the at least one food particulate moves freely in the cavity.

### CROSS-REFERENCE TO RELATED APPLICATIONS

This application claims the benefit of U.S. Provisional Patent Application Ser. No. 60/975,828 for a PARTICULATE FILLED EDIBLE PRODUCT AND PROCESS FOR MAKING, filed on Sep. 28, 2007, which is hereby incorporated by reference in its entirety.

### BACKGROUND OF THE INVENTION

1. Field of the Invention

The present invention relates to an edible food product, more particularly to a particulate filled edible food product and a method of making the same.

2. Description of the Prior Art

Food products having an exterior shell component and a filler component can be desirable because they can possess more than one flavor or texture in a single piece. It is known to produce multi-component, filled food products by extrusion. In extrusion, a concentric layer or layers are extruded around a core material. The core material is completely enclosed by the shell material. The U.S. Pat. No. 3,764,715 (hereinafter the '715 patent) to Henthorn et al. discloses a process for making a ready-to-eat cereal piece in which a cereal dough is extruded around a syrup-like liquid. In the method disclosed in the '715 patent, the extruded cereal dough completely encloses the syrup-like liquid.

U.S. Pat. No. 3,366,484 (hereinafter the '484 patent) to Weiss et al. discloses a ready-to-eat cereal and a process for making the same. The ready-to-eat cereal comprises two layers of cooked dough forming a shell. A dough-fruit mixture, comprising crumbs of dough and particles of dried fruit are enclosed between the two layers of dough. Dough consisting primarily of wheat is cooked to have a moisture content of about 30%. A first portion of this cooked dough is run through a set of shredding rolls, and a first shredded sheet having a thickness of about 0.05 inch is laid down. A second portion of this cooked dough is run through a set of shredding rolls and then broken down in a coarse grinding mill to form a batch of dough crumbs. Dried fruit particles having a particle size such that they would pass through a U.S. No. 12 screen are mixed with the dough crumbs and the dough-fruit mixture is spread over the first shredded sheet. A second shredded sheet, with the same dimensions as the first shredded sheet, is laid over the dough-fruit mixture. The same dough is used for first shredded sheet, dough crumbs, and second sheet of dough. The layered sheets are then cut to form a plurality of square biscuits. The biscuits are then dried to a moisture content of about 5%. Lastly the biscuits are toasted at 400° for 3 minutes to form the finished product. The '484 objective is to project the fruit within the shell to obtain a delectable product. Based on sheet thickness, composition, and moisture content a solid product would be formed with no puffing occurring between the first and second shredded sheets.

### SUMMARY OF THE INVENTION

The subject invention relates to a particulate filled edible product and a method of making the particulate filled edible product. The edible product comprises an edible shell of dough that defines an enclosed cavity having a cavity volume. At least one edible food particulate is disposed within the cavity. The food particulate has a particulate volume that is less than the cavity volume and the at least one food particulate moves freely in the cavity.

### BRIEF DESCRIPTION OF THE DRAWINGS

The present invention will be readily appreciated in view of the following detailed description of an exemplary embodiment of the broader invention, accompanied by the following drawings:

FIG. 1 is top view of an edible item of the exemplary embodiment of the broader invention;

FIG. 2 is a front view of the exemplary embodiment;

FIG. 3 is a right-hand view of the exemplary embodiment;

FIG. 4 is a cross-section taken along section lines 4-4 in FIG. 1; and

FIG. 5 is a simplified flow diagram illustrating the steps of an exemplary embodiment of the invention.

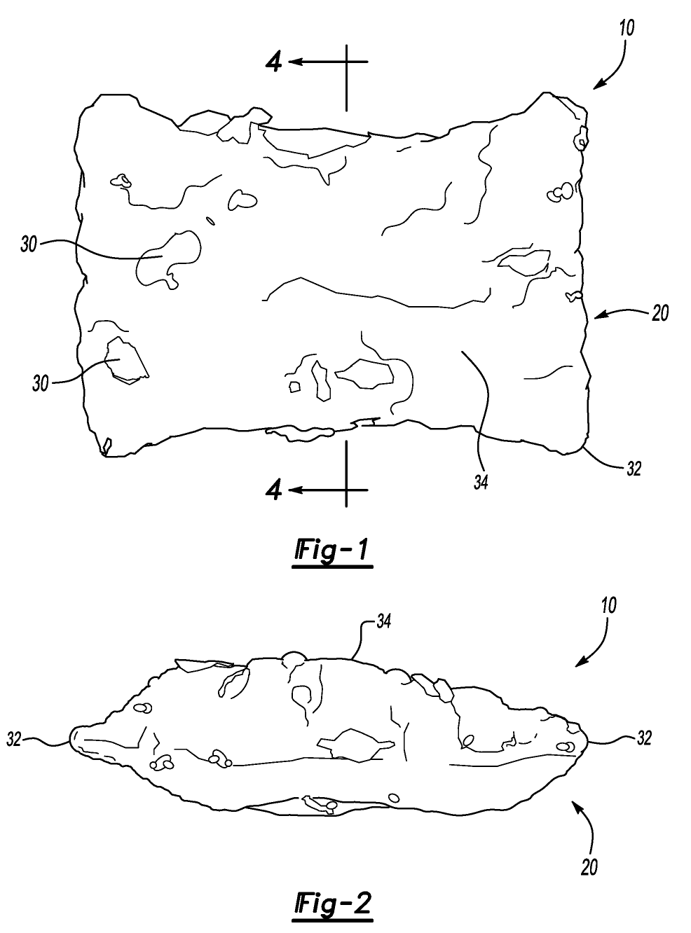

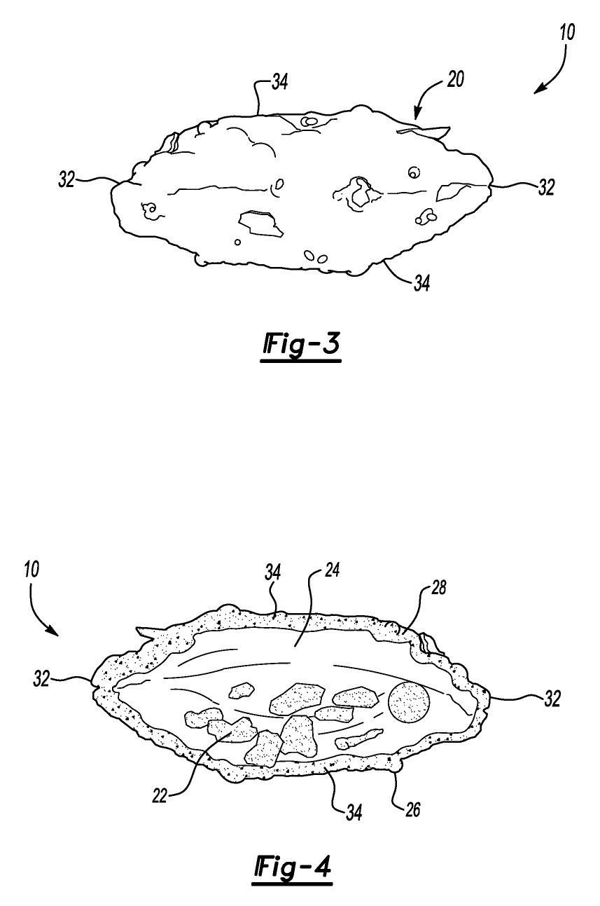

### DETAILED DESCRIPTION OF THE EXEMPLARY EMBODIMENT

An edible product 10 is an exemplary embodiment of the broader invention and includes an edible shell 20 and an edible food particulate 22. The shell 20 is hollow and defines a closed cavity 24 which has a volume. The food particulate 22 also has a volume and the volume of the food particulate 22 is less than the volume of the cavity 24. The food particulate 22 is disposed in the cavity 24 and is loosely enclosed by the puffed shell 20 so as to be free to move about the cavity 24. The particulate may be any shape known in the art.

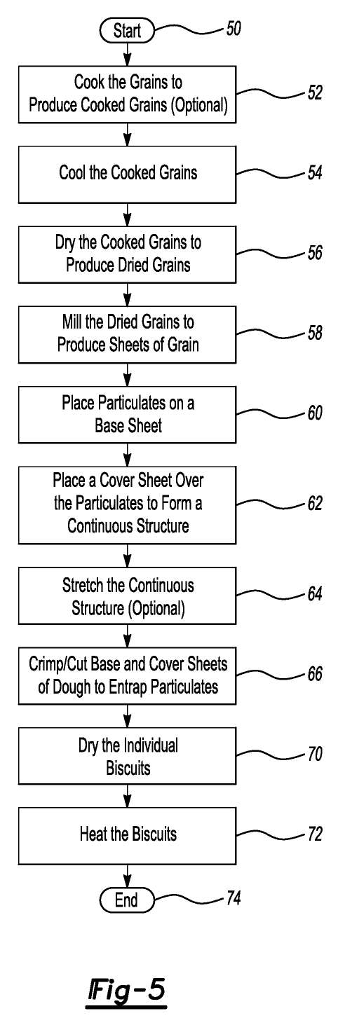

A method according to an exemplary embodiment of the invention is shown schematically in FIG. 5. The method starts by preparing a pre-gelatinized sheet of dough. The degree of gelatinization will affect the capacity of the sheet to stretch without tearing. Factors that can effect the degree of gelatinization of the sheet include, without limitation, bran content, grain profile, starch content, fat content, sheet thickness, the mill profile, and the moisture content.

An exemplary method for making a sheet starts at step 50 and includes step 52 of cooking grains in water. The grains can be a mixture of corn and rice (for example brewers grits) at a level of 60-100% starch with cook moisture of 24-34%. The use of these grains can result in a strong and flexible sheet. The small brewers grits can eliminate hard spots in the finished product. Of course, other grains may be used in alternative embodiments of the invention. In alternative embodiments of the invention, gains that contain bran, such as whole wheat, barley, proteinacious blends, or whole oats can be added to the mixture. However, these grains may weaken the sheet, produce holes in the dough, and result in a more fragile finished product, thus the amounts of whole wheat, barley and whole oats should be limited, but can be added. Further, the grains used are a parameter that must be considered when creating a puffed product. Some grains, such as corn and rice due to their starch content and profile are more easily puffed then grains such as whole wheat. Purified sources of starches known in the art may be used, including but not limited to, wheat starch and tapioca starch.

During cooking of the dough for making the exemplary sheet, the ferenacious grains absorb moisture and soften. The grain mixture can be cooked in a pressurized vessel. This cooking step is optional. Alternatively, the grain mixture may be cooked using other gelatinizing methods. At step 54, the grain mixture is cooled. In an exemplary embodiment, the corn/rice mixture is cooled by convection with ambient air. However, the cooling can also be achieved by a cooling conveyor belt or by other suitable cooling methods.

At step 56, the cooled, moist grains are dried to remove a portion of the moisture. An exemplary moisture level range of the cooled, moist grains is about 24-30%. However, this range can vary based on other process parameters. In an exemplary embodiment, the grain mixture is dried by convection with air, but drying can be achieved by a heated conveyor belt or by other suitable drying methods. At this time, the dried grains may be optionally cooled. At step 58, the dried grains are milled to form sheets of dough. The mills can be used to produce a mill pattern in at least one of the sheets of dough. Any mill pattern known in the art may be used.

The sheets are conveyed and/or split or folded to form a first or base sheet of dough and a second or cover sheet of dough, each having a thickness. An exemplary thickness for the sheets is 0.01 to 0.06 inches. In the preferred embodiment, the thickness of the sheet is approximately 0.015 to 0.04 inches. Thickness of the sheets is another parameter that must be considered when creating a puffed product. The thicker the sheet the more difficult puffing becomes. Each of the flat sheets contain a plurality of crimping portions 32 and cavity portions 34. The crimping portions 32 are at the perimeter of the shells 20 while the cavity portions 34 are portions of the flat sheets that will later puff during the heating step to form the cavity 24.

At step 60, at least one, but preferably a plurality of edible food particulates 22 are placed on the first sheet of dough formed in the milling step. The particulates 22 are randomly deposited on the first sheet of dough. In one example, the particulates 22 can be arranged in lines with each of the lines running parallel the length of the base sheet. Additionally, the particulates 22 can be arranged such that rows of particulates 22 are formed perpendicular to the length of the first sheet. In other words, each of the particulates 22 can be aligned in one line and one row and the lines and rows can be perpendicular to one another. Alternatively, the particulates 22 can be arranged in other patterns.

In an exemplary embodiment, each of the particulates 22 is of a size less than the puffed volume of the cavity 24. By decreasing the volume of each particulate 22, a proportionately smaller cavity 24 in the shell 20 is required to loosely enclose the respective particulate 22. If a particulate 22 having a larger volume is utilized, a proportionately larger cavity 24 would have to be formed in the shell 20. While the particulate 22 may be any size and shape known in the art, in the preferred embodiment, the particulates 22 are of such size that they would pass through a U.S. No. 2 screen, but would sit on a U.S. No. 12 screen. In one example, the particulate 22 is a dehydrated blueberry. In the alternative, the particulate 22 could be another fruit, a nut, a ready-to-eat (RTE) cereal, cluster piece, baked cookie piece or any other suitable food product. A plurality of particles can be grouped together to be contained in a single shell 20. The shell 20 has the ability to protect certain said particulates 22 from alteration by heat if so desired. Subsequently, nutritionally enhanced/fortified ingredients may be protected from degradation if so desired.

At step 62, the second sheet or cover sheet of dough is placed over the placed particulates 22 and the first sheet as well. The second sheet can be substantially the same as the first sheet with respect to ingredients and process for making. The second sheet is placed on the first sheet so that the corresponding cavity portions 34 and crimping portions 32 of the first and second sheets are aligned. The result of step 62 is a continuous layered structure having a plurality of edible food particulates 22 disposed between the first and second sheets.

In the example, at step 64, the continuous layered structure is preferably stretched. This step can be desirable because the dough of the continuous structure will be kept taught and maintain the placement of the particulates 22. In an exemplary embodiment, the stretching is accomplished by setting the rotational speed of the rotary cutter slightly faster than the speed of the conveyor belt. As a result, the rotary cutter pulls the continuous structure forwardly thus stretching the continuous structure.

At step 66, the second sheet of dough is mechanically interlocked or crimped to the first sheet of dough around each of the particulates 22 in the crimping portion 32. At this time the sheets are severed. Once severed from the continuous structure, each of the dough-covered particulates 22 become individual discrete shaped biscuits or shells. In an exemplary embodiment, each biscuit has a base piece 26 of dough and a cover piece 28 of dough which are in crimped engagement with one another. During the severing process, each base piece 26 is severed from the first sheet and each cover piece 28 is severed from the second sheet.

The crimping and the severing may be accomplished by utilizing a rotary cutter. The rotary cutter includes a rotating drum with a plurality of shaped dies protruding therefrom. As the continuous structure is moved into the rotary cutter on a conveyor belt, the drum rotates downwardly toward the conveyor belt thus pressing the dies into and through the continuous structure. The crimping is performed as the die presses the second sheet into the first sheet and the severing is performed as the die engages the conveyor belt, i.e. as the die cuts through the dough. A roller having a flat surface may be used instead of the conveyor belt. In such as system the rotating drum and roller would rotate together to pull the first and second sheets through the rotary cutter. As the first and second sheets are pulled through the rotary cutter the drum would rotate to press the dies into and through the continuous structure. The crimping is performed as the die presses the second sheet into the first sheet and the severing is performed as the die engages the roller, i.e. as the die cuts through the dough. In the exemplary embodiment of the invention, the combination of the square shaped dies and the stretching performed at step 64 result in a pillow shaped biscuit. Any shaped die known in the art may be used to achieve the desired shape of the biscuit.

At step 70, the individual biscuits are dried and become firmer. In an exemplary embodiment, the biscuits are dried by convection with heated air. Alternatively, the drying can be achieved by a heated conveyor belt or by other suitable heating methods known in the art. An exemplary final moisture level range of the dough of the dried biscuits is about 6% to 15%, preferably 10% to 12%. However, this range can vary based on other process parameters. The moisture content prior to heating is a parameter in allowing for a puffed product. A moisture content that is too low, i.e., about 5% will not result in a puffed product.

At step 72, the dried biscuits are heated to puff the outer surfaces. During this step, the moisture remaining in the dough causes the base piece 26 and the cover piece to move apart, expanding the biscuit to form a shell and the cavity 24. The at least one particulate 22 is now loosely enclosed in the cavity 24 and moves freely in the cavity. Step 72 can also result in blisters 30 being formed on the outer surfaces of the biscuits. Additionally, the outer surfaces can become darker, or browned. The final color of the biscuits can be a golden brown. The combination of the blistering and browning significantly reduces the appearance of the mill pattern left by the milling process. As a result, the puffed biscuits take on a fried appearance despite the fact that they have been baked. This appearance can be desirable to consumers. Additionally, the puffing results in a more crunchy texture. In one example, the heating is accomplished via a fluidized bed oven, and the targeted final moisture content of the finished biscuit is 2%-6%. The method ends at step 74.

In addition to fluidized puffing, the biscuits could be deep-fried in hot oil. Applying to deep-frying to make an alternative embodiment of the invention may require varying the components and parameters of the sheets of dough. For example, biscuits can be formed from dough having a quantity of starch, by dry basis, of 30%-100% and this may result in a dough more suited to deep-frying. These quantities of starch can also be used to practice an embodiment of the invention that is baked as well. Also, the thickness of the sheets of dough can be varied from 0.010-0.060 of an inch.

Further, an additive may be applied to an outer surface of the shell after the heating step. The additive is at least one of frosting, vitamins, edible particulates, flavoring, artificial sweeteners, or coloring. In an exemplary embodiment, a vitamin belt may be used in applying the additive. A sprayer could be used to apply the additive as the puffed shell moves along the vitamin belt.

The above described method is advantageous in that it provides for a puffed product having a particulate disposed therein. In addition to providing a product desirable to consumers, the shell also protects the food particulate from alteration by heat such that overall taste, flavor and nutritional quality of the at least one food particulate is not degraded.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method for forming an edible product comprising the steps of:
producing first and second sheets of dough;
disposing at least one edible food particulate on the first sheet of dough;
covering the first sheet of dough with the second sheet of dough;
crimping and cutting the first and second sheets of dough to enclose the at least one edible food particulate and create a biscuit; and
heating and puffing the biscuit to define an enclosed cavity for enclosing the at least one edible food particulate in the cavity and allowing the at least one food particulate to move freely in the cavity.

2. The method of claim 1 further comprising the step of:
cooking a cereal grain mixture to a moisture content of about 24-34% prior to the producing first and second sheets of dough step.

3. The method of claim 2 further comprising the step of:
drying the cooked cereal grain mixture to a moisture content of about 24%-30%.

4. The method of claim 1 wherein the producing first and second sheets of dough step is further defined as milling a cereal grain mixture to form first and second sheets of dough.

5. The method of claim 1 wherein the producing first and second sheets of dough step is further defined as forming first and second sheets of dough, each having a thickness of about 0.01 to 0.06 inches.

6. The method of claim 1 wherein the producing first and second sheets of dough step is further defined as forming first and second sheets of dough, each having a thickness of about 0.015 to 0.04 inches.

7. The method of claim 1 further comprising the step of:
drying the first and second sheets of dough to a moisture content of about 6%-15% prior to the heating step.

8. The method of claim 1 further comprising the step of:
drying the first and second sheets of dough to a moisture content of about 10%-12% prior to the heating step.

9. The method of claim 1 further comprising the step of:
applying an additive to an outer surface of the biscuit after the heating step.

10. The method of claim 9 wherein the additive is at least one of frosting, vitamins, edible particulates, flavoring, or coloring.

11. The method of claim 1 wherein the at least one edible food particulate will not pass through a U.S. No. 12 screen.

12. The method of claim 1 wherein the disposing step is farther defined as disposing at least one of fruit, nuts, a ready-to-eat cereals, cluster pieces, or baked cookie pieces on the first sheet of dough.

13. The method of claim 1 further comprising the step of:
milling at least one of the first and second sheets of dough to produce a visible mill pattern in the biscuit.

14. The method of claim 1 wherein the heating and puffing the biscuit step is further defined as heating the biscuit to form a blister-like outer surface on the biscuit.

15. An edible product comprising:
an edible shell of dough defining an enclosed cavity having a cavity volume; and
at least one edible food particulate disposed within said cavity and having a particulate volume being less than said cavity volume and said at least one food particulate moving freely in said cavity.

16. The edible product as set forth in claim 15 wherein said shell farther comprises:
a first sheet of dough; and
a second sheet of dough crimped to said first sheet of dough to define said enclosed cavity.

17. The edible product as set forth in claim 16 wherein said first and second sheets of dough puff from each other when heated.

18. The edible product as set forth in claim 15 wherein said edible shell of dough is formed of cooked cereal grains.

19. The edible product as set forth in claim 15 wherein said at least one edible food particulate will not pass through a U.S. No. 12 screen.

20. The edible product as set forth in claim 15 wherein said at least one edible food particulate is at least one of fruit, nuts, a ready-to-eat cereals, cluster pieces, or baked cookie pieces.

21. The edible product as set forth in claim 15 wherein said shell has an outer surface displaying a blister-like appearance.

22. The edible product as set forth in claim 15 wherein said shell is pillow shaped.

23. The edible product as set forth in claim 15 including a plurality of food particulates.
